(19) United States
(12) Patent Application Publication
(10) Pub. No.: US 2018/0251080 A1
(43) Pub. Date: Sep. 6, 2018

(54) Seatbelt Holder For Mobile Communication Devices

(71) Applicant: Signal Essence, LLC, Mounain View, CA (US)

(72) Inventors: Hugh Joseph McLaughlin, Mountainview, CA (US); Caleb Henry Crome, San Jose, CA (US); Ryan McLaughlin, Mountain View, CA (US); Michael Romero, Ventura, CA (US); Jackson Rapaich, Foster City, CA (US); Quang Nguyen, San Jose, CA (US)

(21) Appl. No.: 15/893,258

(22) Filed: Feb. 9, 2018

Related U.S. Application Data
(60) Provisional application No. 62/466,736, filed on Mar. 3, 2017.

(51) Int. Cl. B60R 11/02; B60R 22/00

(52) U.S. Cl. CPC B60R 11/0241; B60R 22/00

(57) ABSTRACT

A holder for a smart phone that attaches to a seatbelt by using a scoop to pick up a seatbelt and then distort the seatbelt to secure the holder to the seatbelt. The holder includes a spring-loaded sliding jaw to accommodate insertion of the phone using a single hand. Once the phone is inserted, the smart phone is held in place by the spring-loaded sliding jaw which presses the smart phone against a non-moving jaw. The holder includes features that allow for easy one-handed operation including a landing area for the user's thumb, a flange to aid in removal of the smart phone, a tread to add friction to one of the thumb areas. The sliding jaw is located opposite of the point of the scoop.

### CROSS REFERENCE TO RELATED APPLICATIONS

Pursuant to 35 U.S.C. § 119(e), this application is entitled to and claims the benefit of the filing date of U.S. Provisional App. No. 62/466,736 filed Mar. 3, 2017, the content of which is incorporated herein by reference in its entirety for all purposes.

### BACKGROUND

Embodiments of the present disclosure generally relate to smart phones, and more particularly relate to a holder for holding a smart phone onto a seatbelt for ease of use of the smart phone while driving.

Mobile devices, such as smart phones, are used in a variety of environments for communication. Numerous environments in which smart phones are used require essentially hands free operation of the smart phones for safe use. One environment in which hands free use of smart phones is increasing is the automobile environment in which a driver of an automobile may be required to operate the automobile with minimal handling and minimal visual interaction with the smart phone while driving. Numerous governments have legislation requiring hands free use of smart phones while driving automobiles and drivers have generally become aware that hands free use of smart phones while driving improves safe driving. Various devices provide a limited solution for hands free use of smart phones while driving. Some of the devices that provide for hands free use of mobiles phones while driving include: i) wired headsets that include microphones and relatively small speakers (e.g., transducers) that fit into or onto a user's ear; ii) wireless headsets, such as Bluetooth devices; iii) a hands-free wireless speakerphone, such as a Bluetooth device that mounts either on the dashboard or the sun visor; iv) a hands-free factory-installed Bluetooth speakerphone device; and v) a hands-free kit designed to dock a smart phone where the hands-free kit provides a relatively large speaker and a directional microphone; vi) a holder that acoustically couples the loudspeaker of the cell phone into an acoustic horn that is designed to mount to a windshield or to an air vent, and vii) a seatbelt clip that uses a spring-loaded clip with an acoustic aid to increase the volume of the sound.

Each of these devices has specific limitations in providing its intended function. For example, wired headsets are cumbersome to handle. A wired headset includes a headset plug that needs to be plugged into a jack of a smart phone, and includes an earpiece that needs to be positioned onto a user's ear. Wireless headsets similarly include an earpiece that needs to be positioned onto a user's ear, and must be charged for use. Trying to put an ear piece onto one's ear while driving and trying to answer a call is difficult for many people and can therefore be very distracting. Further, making sure a wireless headset is charged for use is difficult for many users. Speakerphone devices often have microphone sensors that are placed relatively far (e.g., 30 centimeters or more) from a user's mouth. Considering an automobile's noisy environment, there is typically a relatively large amount of noise that is picked up by the microphones of the speakerphone device. Further a speakerphone kit needs to be installed and can be expensive. In the case of the holder with an acoustic horn, the present art teaches that the holder should be attached to a windshield by suction cup, or mounted to an air vent, or attached to a dashboard. With a smart phone docked in a relatively open space in an automobile, such as on a dash board, sound reaching a microphone of a smart phone from the talker may be distorted from reflections inside the automobile and the background noise will be relatively large compared to the sound from the talker. In the case of the above-mentioned seatbelt clip, a device the increases the sound level is bulky and must be a close match to the size of the specific cell phone.

A known problem with smart phones is that the loudspeakers are generally weak. The space available in a smart phone for a loudspeaker's transducer is relatively small so the loudspeaker's transducer is neither powerful nor efficient. In an automobile, the sound output of typical smart phones is relatively weak compared to the background noise. Therefore, it is desirable that a holder can hold the smart phone close to the user's ears. It is also desirable that the smart phone can be located close to a flat acoustically opaque surface to increase the effective sound volume.

Additional problems exist with using smart phones while driving, such as diverting one's eyes to the smart phone to operate the smart phone's buttons. Fortunately, many smart phones have adopted an ability to hold down a single button to initiate a voice command. As an example, a command may be “call John Doe on speaker”. In this case a call will be placed to “John Doe” and the sound will be played on the speaker. Users should not have to look at the phone to make a call or to read a text. It has been shown that entering text into a phone while driving is more than five times as distracting as merely talking on a smart phone. Users should be discouraged from looking at their smart phone and they should be especially discouraged from looking at the smart phone while entering text with their fingers. Further, no device should require the user to take both hands off of the steering wheel, so all operations should require only a single hand.

Therefore, an impetus exists for creating a new device for smart phone use in automobiles where the new device aids the user with hands-free operation of their smart phone, provides for relatively clear sound emission, provides for relatively undistorted sound pick-up of a user's speech, is compact in size, fits a large number of smart phones, requires the use of only one hand, can be charged at the same time, and discourages humans from looking at their phone.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a front view of the holder according to one embodiment.

FIG. 2 is an end (bottom) view of a holder's fixed jaw according to one embodiment.

FIG. 3 is an end (top) view of the holder's sliding jaw according to one embodiment.

FIGS. 4A, 4B, 4C, 4D show a side view of the holder illustrating smart phone insertion according to one embodiment.

FIG. 5 is a rear view of the holder according to one embodiment.

FIGS. 6A, 6B, 6C illustrate a seatbelt insertion sequence to show the concept of the seatbelt scoop feature.

FIG. 6D is a cross-sectional view of the holder.

FIG. 7 shows an exploded view of the parts according to one embodiment.

FIG. 8 shows a perspective view of a holder in accordance with the present disclosure.

FIG. 9 is a simplified front view of the holder attached to a seatbelt, which is over a user's chest and torso.

FIG. 10 is a simplified side view of the holder attached to a seatbelt, which is over a user's chest and torso.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

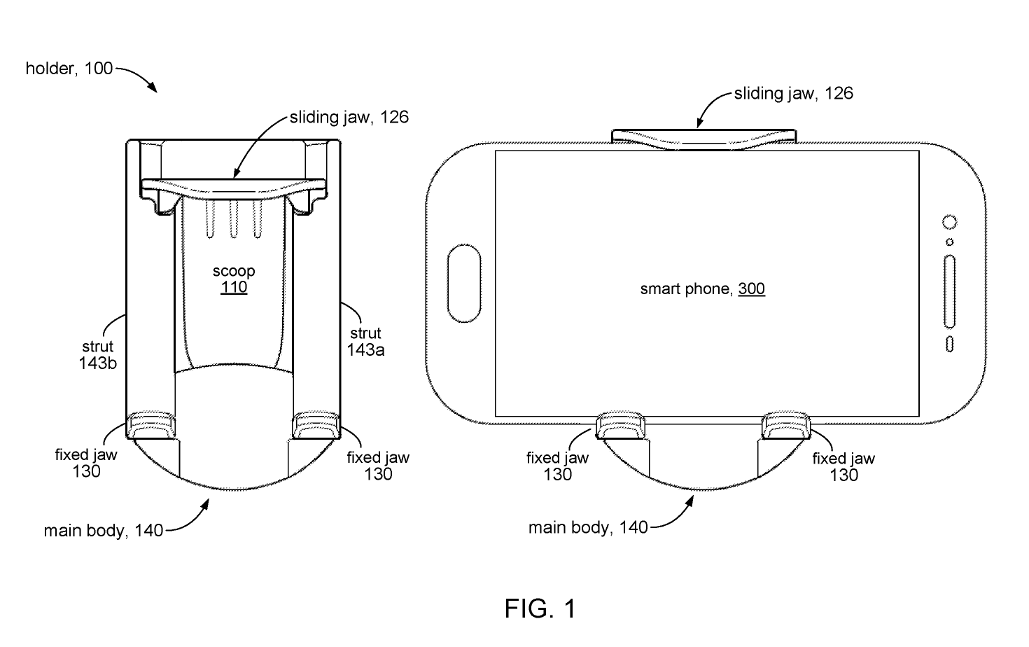

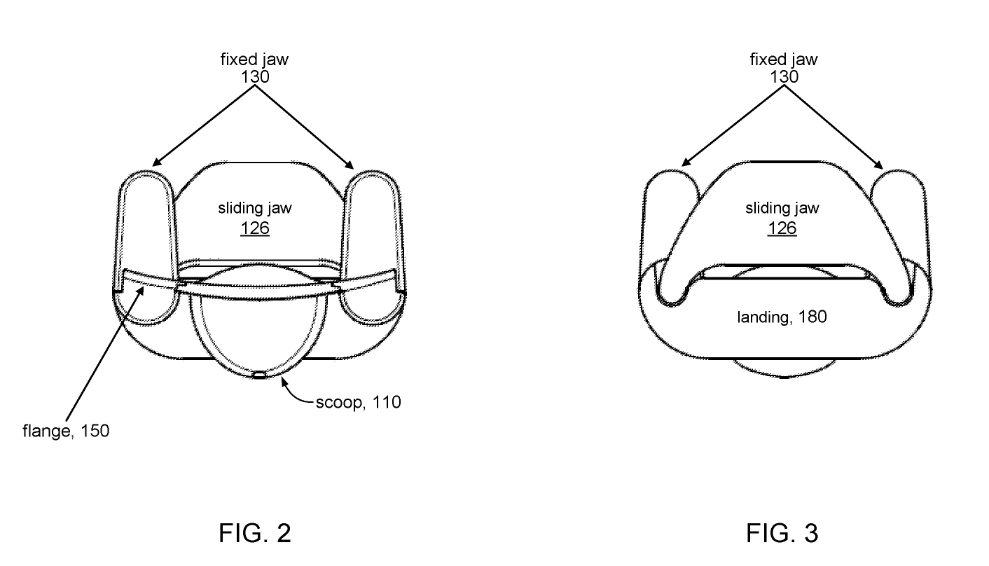

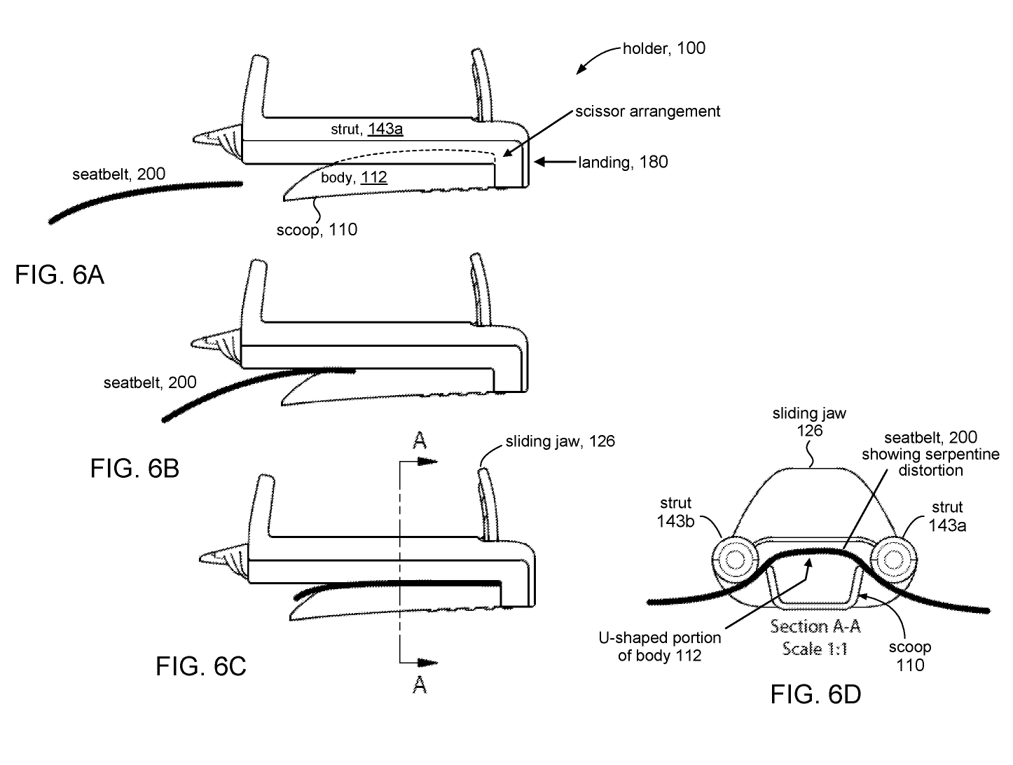

Embodiments of the present disclosure generally provide a holder 100 (FIG. 1) for a smart phone 300 (FIG. 1) or other mobile communication device, and provides a holder configured to hold a smart phone on a seatbelt 200 (FIGS. 6A-6D) relatively close to a user's body for relatively simple ergonomic use and eyes-free operation.

Smart phones often have two microphones for detecting sound, such as a user's speech. A first microphone is often near a bottom of a smart phone, and a second microphone is often near a top of the smart phone. The first microphone at the bottom of the smart phone may be used for detecting a user's voice with the smart phone held near, or against, a side of a user's head (“normal” use position) with the first microphone proximate to the user's mouth. The second microphone is often used for “hands-free” talking where the smart phone is not in the normal use position but is positioned away from a user's head. The first and the second microphones are often coordinated by the smart phone's signal processor to reduce undesired noise detected by the microphones from being transmitted from the smart phone in a smart phone call.

Smart phones also often include two transducers for producing sound. A first transducer is often near the top-front of a smart phone and a second transducer is often on the lower back or bottom of the smart phone. The first transducer is typically configured for use near a user's ear with the smart phone near, or against, a person's head. The second transducer may be a loudspeaker that produces louder sounds than the first transducer and may be for speakerphone use. The two transducers are typically distant from the microphones to minimize problems with echo coming into the microphones. Generally, for a smart phone to operate well, the smart phone and the smart phone's microphones may be configured to minimize echo of sound entering the microphones. It is typical that in “normal” mode the sound-making transducer is at the top of the phone near the user's ear, while the microphone is at the bottom. It is typical that in “speakerphone” mode, the positions are the opposite of “normal” mode, with the “speakerphone” loudspeaker near the bottom and the “speakerphone” microphone near the top. For some smart phones such as the Apple iPhone™ line of phones, the speakerphone loudspeaker is at the bottom of the phone. For many other smart phones, the speakerphone loudspeaker is on the back of the phone, but near the bottom.

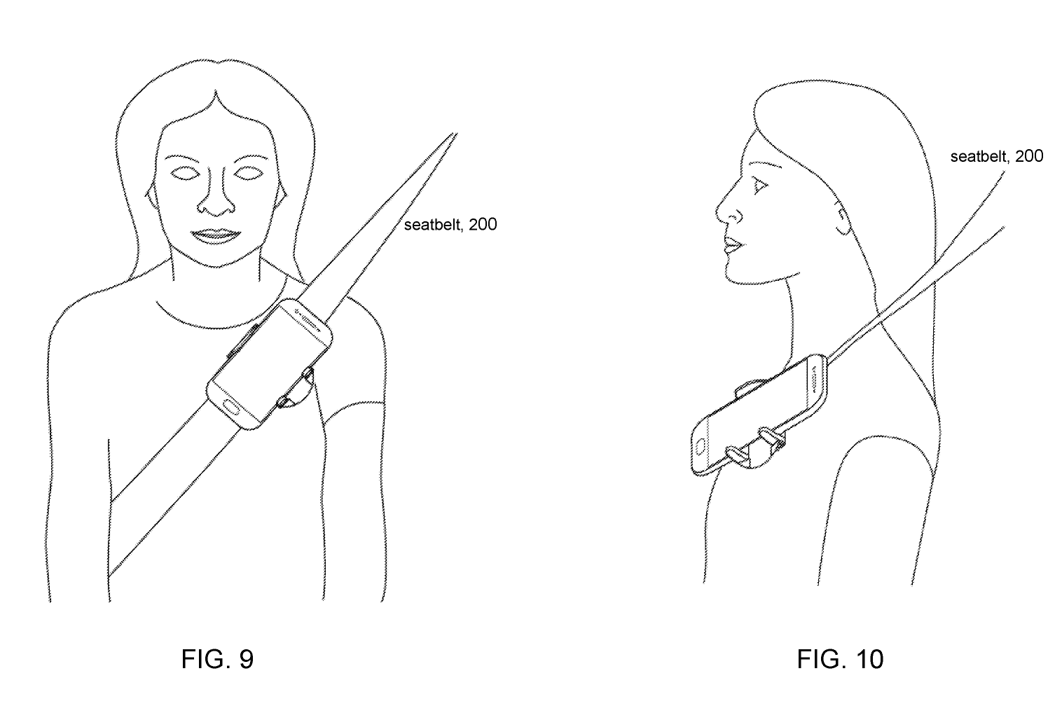

Modern smart phones are also referred to as smart phones. In general, a smart phone includes a touch sensitive display and one or more hardware buttons. The present disclosure describes a seatbelt holder 100 (FIG. 1) that aids the performance of a smart phone. The holder is specifically targeted toward the common over-the-shoulder seatbelt 200 (FIG. 9). The holder positions the speakerphone microphone close to the user's mouth, and holds the loudspeaker in a stable position to stabilize the echo path. The main “home” button is easily detected by the user by feeling for it at the bottom of the phone. The hard button controls such as volume control are conveniently accessible as those buttons are usually along the top of the side edge of the smart phone.

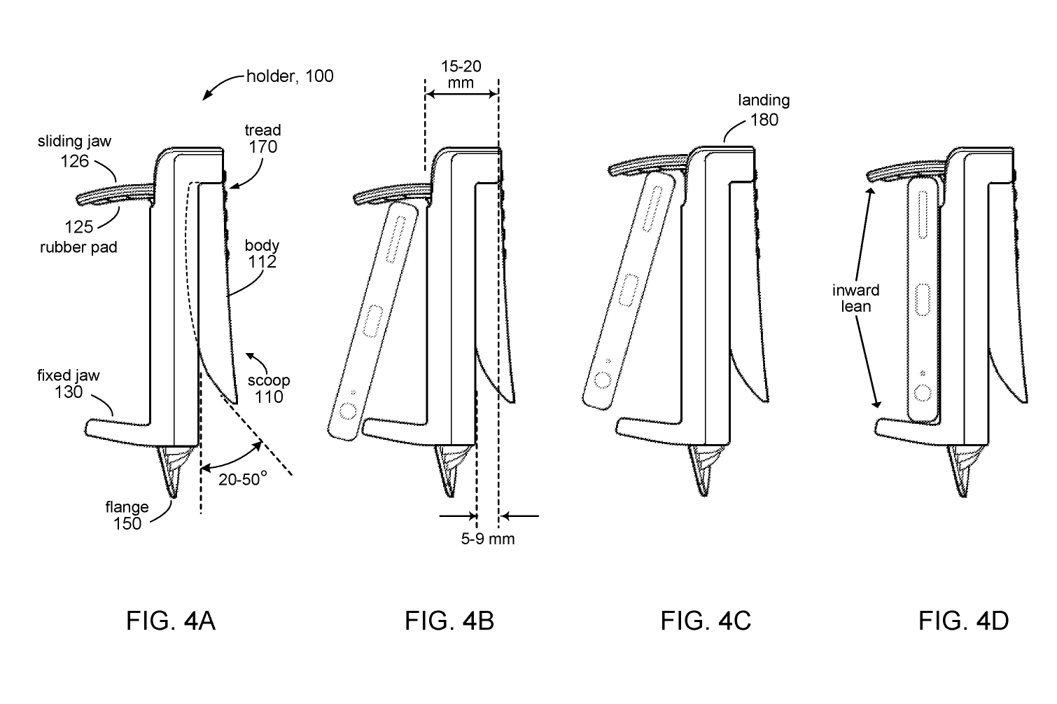

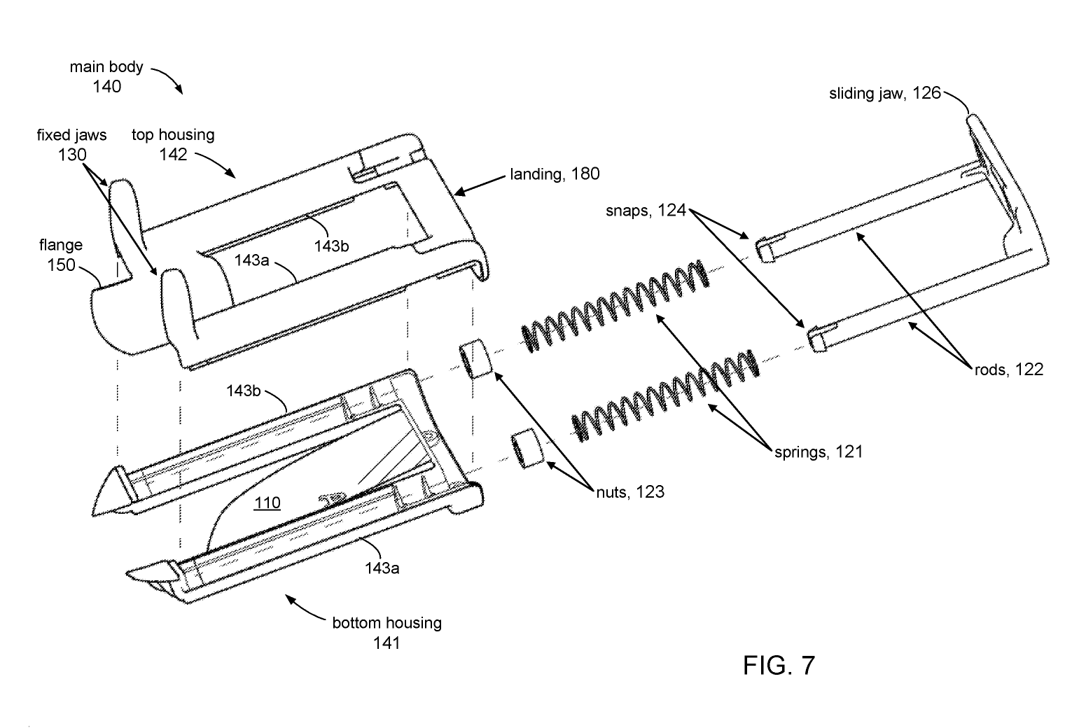

Referring to FIG. 1, the holder 100 is designed for one-hand operation and ease of use. It has specific features to make it easy to use with one hand. The holder may include set of jaws 126, 130 and a main body (frame) 140. One of the jaws is a spring-loaded sliding jaw 126. The sliding jaw has rods (FIG. 7) that slide inside the main body in a housing 140 that keeps the springs and sliding rods hidden from the user. There is a second jaw that is a fixed jaw 130 that has two prongs opposite of the sliding jaw 126. Both the sliding jaw 126 and the fixed jaw 130 lean inward (FIG. 4D) so that the smart phone will stay in place once it is inserted.

The holder 100 also has a scoop 110 that is designed to pick up and catch a seatbelt 200. The scoop is attached to the main body, either by a mechanical connection or is formed as part of the main body. A distal end of the scoop 110 sweeps or curves away from the main body 140. In some embodiments the swept end can form an angle with the main body of about twenty to fifty degrees (FIG. 4A) that allows the holder to pick up a seatbelt 200 by merely moving the holder 100 in a motion across the seatbelt, as shown in the sequence in FIGS. 6A, 6B, and 6C. The body 112 of the scoop has an overall depth of at least 5 millimeters and preferably 9 millimeters (FIG. 4B). In this embodiment, the scoop has a U-shaped cross section. As can be seen in FIG. 6A (and FIG. 4A), the scoop overlaps the struts 143a, 143b in a scissor arrangement. The seatbelt is secured between the body 112 of the scoop 110 and the main body 140 by friction contact to secure the holder onto the seatbelt. The holder can be further secured to the seatbelt by distorting the seatbelt as the seatbelt is slipped between the scissor arrangement of the scoop 110 and the struts 143a, 143b (FIG. 6A) and forcing the seatbelt to bend between the body of the scoop and the struts 143a, 143b on each side of the scoop (FIG. 6D). The serpentine bend in the seatbelt provides mechanical support and additional friction to keep the holder in place. The U-shape cross section has the following advantages over other cross section choices: 1) it is moldable by plastic injection molding, 2) it allows for a tread on the underneath portion of the scoop where a person may put their thumb, 3) it provides a substantially flat area that will be comfortable on a user's chest, 4) it provides sufficient thickness to lift and distort the seatbelt, and 5) it is strong and can be further supported by interior ribs. It is understood that a U-shape cross section is one of many cross sections that can work to lift the seat belt and the distort the seatbelt into a serpentine shape.

The holder has a flange area 150. This flange 150 is useful for releasing the phone and it also has a dual purpose of keeping the seatbelt 200 from getting caught when trying to slide the holder off the seatbelt. It is important that the flange 150 overlaps with the seatbelt so that the seatbelt will not snag onto the device when withdrawing the holder from the seatbelt.

Embodiments of the present disclosure allow for one-handed operation for user actions. To attach the holder to the seatbelt, the user simply slides the holder across the top of their chest in a direction going from the middle of the car toward the door of the car. The scoop 110 will scoop up the seatbelt 200 and the force of moving the holder across the seatbelt will direct the belt over the scoop and into the secure position. As the belt is scooped the seatbelt distorts into a serpentine shape as shown in FIG. 6. This serpentine shape provides additional friction and structural support to hold the weight of the smart phone securely in place. The smart phone is inserted into the holder by using one hand and simply pressing one edge of the smart phone against a spring-loaded sliding jaw 126. The holder has a convenient flat landing (rest area) 180 for the user's thumb to press against the holder to provide an opposite force so that holder does not move while inserting the phone.

The smart phone is held in place by the pressure of the spring-loaded sliding jaw 126. The sliding jaw also has a rubber pad 125 to provide additional friction against the edge of the smart phone to keep it from sliding out due to gravity.

To release the phone from the holder the user has a few options. First, the user can simply rip the phone out by pulling on the side of the phone that is against the non-moving jaw 130, pivoting the side of the phone that is against the sliding jaw 126. The non-moving jaw does not have rubber, so there is little friction on that side. A second option is for the user to slide their finger or fingers between the phone and the flange 150. A third option is for the user to slide one finger under the phone while another finger presses against the flange 150. The user can select whichever method is most natural for them.

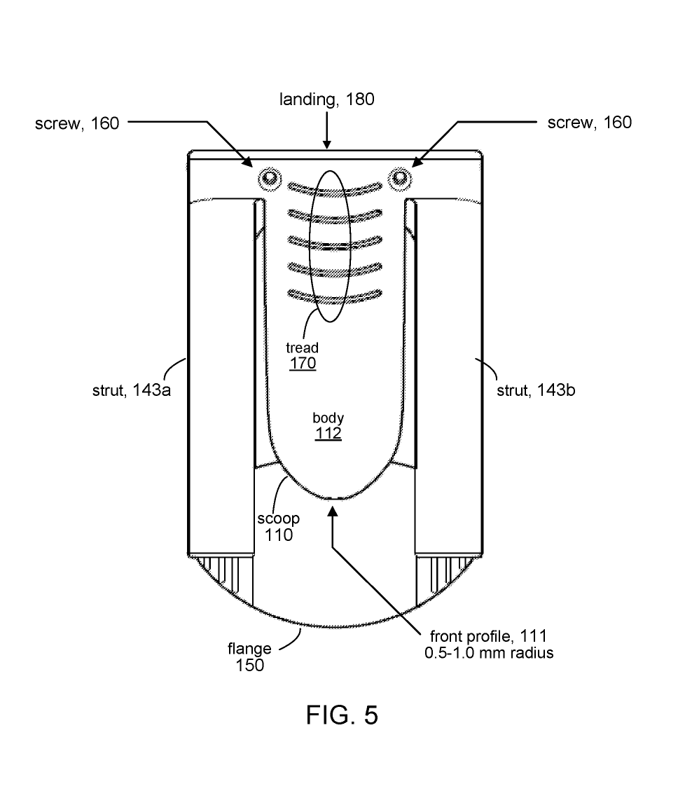

The scoop 110 has been designed to easily pick up a seatbelt. The scoop can have a front profile 111 that shows the scoop is rounded and comes to a point. The point 0.5-1 mm (FIG. 5) of the scoop should not be so sharp that it will catch on clothing and specifically features such as shirt pockets, but sharp enough to make sure it will get underneath the seatbelt reliably. Our experiments showed that the point should have a radius of approximately 0.5-1.0 millimeters. The scoop has a body 112 that has a cross-section that is U-shaped. This gives the scoop strength and makes it moldable by plastic injection molding. The scoop lifts the seat belt and as the holder is pressed against the seatbelt the seatbelt distorts to make a serpentine shape. The edges of the scoop is close to the housing, but leaves room so that the seatbelt does not bind when it is time to pull the holder off of the seatbelt. The serpentine-distorted seatbelt naturally stays in place because there is much friction caused by the bending of the belt. This is somewhat analogous to ladder clasps used to secure straps in place. The mere bending of the seatbelt “strap” causes the holder to be quite secure and keeps the holder in place and keeps the holder from rocking from one side to another.

Referring to FIGS. 4A-4D, insertion of the phone from a starting position (FIG. 4A) of the holder 100 is illustrated. When the phone is inserted, the user can simply press the phone into the gap defined between the sliding jaw 126 and the fixed jaws 130 by pressing one edge of the phone against the movable sliding jaw 126 (FIG. 4B). When pushing in one direction, there must be an opposing force in the other direction to prevent the holder from moving out of position. The user can supply that opposite force quite naturally by using their thumb and pressing on the thumb landing 180 (FIG. 4C). There is also sufficient friction on the back of the holder to press against the user's chest to supply the opposite force. To aid this friction, there is a tread 170 on the back of the holder. As yet another option, for some users it may be more convenient for them to press their thumb against the back of the holder where the same tread 170 provides friction against the user's thumb. When fully inserted, the inward lean of the jaws 126, 130 can facilitate holding the phone in position within the holder (FIG. 4D).

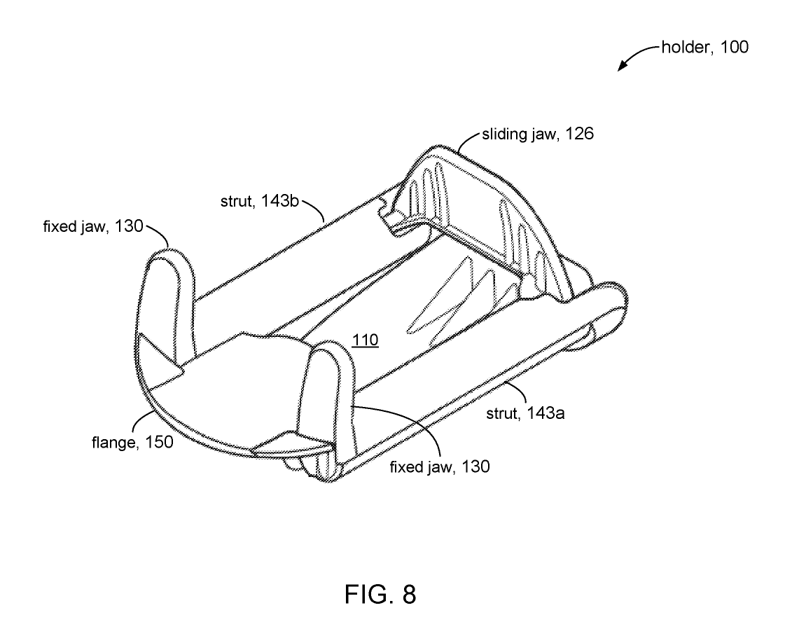

Referring to FIG. 7, the sliding jaw 126 is created by parts including the actual plastic jaw 126, two springs 121, two rods 122, two nuts 123, and snap feature 124 on the end of each rod 122 and a rubber pad on the inside of the jaw. The springs 121 are metal springs. The nuts 123 may be common nylon standoffs. To assemble, the springs are placed over the rods. Then the nuts are pressed over the snap feature 124 until it clicks into place. The assembly is laid into the bottom housing 141. When the top housing 142 is attached then the spring assembly will be hidden within the struts 143a, 143b formed by joining together the top and bottom housing. The struts 143a, 143b may be cylindrical (though not mandatory). The struts should be close enough to the body 112 of the scoop 110 to bend and pinch the seatbelt. In this embodiment, the struts serve the additional role of housing the springs. In this embodiment, two screws 160 (FIG. 5) are used to secure the top housing 142 to the bottom housing 141 on one side. On the other side, the top and bottom housing interlock so that when the two housings are pressed together one end is already secure so it in only necessary to insert screws on the other end. FIG. 8 shows the completed assembly.

The jaws 126, 130 are spaced so that a wide range of smart phones of different sizes and different cases can be accommodated. The resting position of the movable jaw 126 makes a spacing that is slightly less than the width of the smallest smart phone. The jaws lean inward to keep the phone from coming out.

The span of the jaws is designed to avoid pressing against common buttons on smart phones. It is not possible to anticipate all smart phone designs, but most smart phones have volume up and down buttons slightly toward the top of the device. The power button is usually high on the side or on top of the smart phone.

Yet another feature of the holder is that there is 15 to 20 millimeters of space to keep the smart phone sufficiently away from the user's skin to comply with manufacturers recommendations to avoid placing smart phones in contact with the user's skin. This additional space also ensures that the antenna will radiate enough energy to the cell phone toward for communication to remain effective.

As another non-obvious feature, the smart phone is held close enough to the user's chest that it helps boost the low frequencies of the loudspeaker merely by keeping the loudspeaker close enough to the chest to get a modest increase of sound pressure.

A further technical advantage of the invention is the location of the smart phone's microphone to the user's body. As seen in FIGS. 9 and 10, the smart phone is held relatively close to the user's chest. Typical modern smart phones have a microphone near the top of the smart phone to use while in speakerphone mode. The invention puts the top of the smart phone near the user's mouth. This improves the speech-to-noise ratio compared to other speakerphone holders. The location of the top microphone relative to the user's chest improves the sound pickup. Most of the frequencies that come from the talker's mount propagate in all directions with slightly more energy going forward from the user's mouth. However, a microphone held below the user's mouth still picks up most of the user's voice with some small attenuation at higher frequencies above approximately 4 kHz. The sound from the user's mouth arrives by two paths: 1) directly from the talker's mouth, and 2) indirectly by reflection off the talker's chest. As long as the difference in arrival of each path is less than about one-fourth of the wavelength, then there will not be destructive interference of the sound and the sound pressure received by the microphone will be approximately doubled. This further enhances the sound pickup by the microphone.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. Apparatus to secure and electronic device to a seatbelt, the apparatus comprising:
a frame;
a scoop attached to the frame at first end and having a second end that is space apart from the frame, the scoop arranged relative to the frame so that moving the apparatus across a seatbelt picks up the seatbelt at the second end of the scoop allowing the seatbelt to slide between the scoop and frame to secure the seatbelt between the scoop and frame by friction contact to maintain a relative position between the apparatus and the seatbelt;
a sliding jaw configured to slide along the frame; and
a jaw fixedly attached to the frame and disposed in opposition to the sliding jaw to define a gap therebetween for receiving the electronic device.

2. The apparatus of claim 1, wherein the scoop and frame are arranged in scissor fashion so that the seatbelt is distorted when the seatbelt is slid between the scoop and frame to cause the seatbelt to partially wrap around the scoop thereby creating additional friction contact to further secure the apparatus in position relative to the seatbelt.

3. The apparatus of claim 1, wherein the sliding jaw is spring-loaded, wherein insertion of the electronic device between the sliding jaw and the fixed jaw creates a spring-compressed configuration in the sliding jaw which produces a compression force to retain the electronic device between the sliding jaw and the fixed jaw.

4. The apparatus of claim 1, wherein sliding jaw is distal to the curved second end of the scoop.

5. The apparatus of claim 1, wherein the frame includes a landing to accommodate a user's the thumb to provide an opposing force during insertion of the electronic device between the sliding jaw and the fixed jaw.

6. The apparatus of claim 1, wherein the frame further includes a flange area proximate the fixed jaw to accommodate one or more fingers of a user to provide an opposing force during dislodgement of the electronic device from between the sliding jaw and the fixed jaw.

7. The apparatus of claim 1, wherein the sliding jaw includes a rubber pad disposed on an inside surface of the sliding jaw to provide a friction surface for retaining the electronic device between the sliding jaw and the fixed jaw.

8. The apparatus of claim 1, wherein the frame comprises a pair of struts along which the sliding jaw slides, wherein the scoop has a U-shape portion that aligns with the struts in scissor fashion.

9. The apparatus of claim 1, wherein the second end of the scoop has a front profile having a rounded point that has a radius greater than 0.5 millimeters and less than 1 millimeter.

10. The apparatus of claim 1, wherein the curved second end of the scoop forms an angle with the frame between 20 and 50 degrees.

11. The apparatus of claim 1, wherein a surface of the scoop that lies against the user's chest is substantially flat.

12. The apparatus of claim 1, wherein a surface of the scoop that lies against the user's chest includes a tread pattern to provide friction for a user's thumb to provide an opposing force during insertion of the electronic device between the sliding jaw and the fixed jaw.

13. The apparatus of claim 1, wherein the housing, scoop, and sliding and fixed jaws are plastic.

14. The apparatus of claim 1, wherein both the sliding and fixed jaws have an inward tilt to retain the electronic device between the sliding jaw and the fixed jaw.

15. The apparatus of claim 1, wherein a depth of the body of the scoop is at least 5 millimeters.
